(19) United States
(12) Patent Application Publication
(10) Pub. No.: US 2009/0280859 A1
(43) Pub. Date: Nov. 12, 2009

(54) AUTOMATIC TAGGING OF PHOTOS IN MOBILE DEVICES

(75) Inventor: Jonas BERGH, Kavlinge (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/118,874

(22) Filed: May 12, 2008

(51) Int. Cl. H04M 1/00

(52) U.S. Cl. 455/556.1

(57) ABSTRACT

The invention relates to a method for processing a picture file in a mobile communication device. The method includes the steps of obtaining a picture file, detecting a object in the obtained picture file, recognizing the detected object, comparing the detected object with objects in a database, tagging the picture file depending on the comparison, and organizing the tagged picture file depending on the tagging.

### TECHNICAL FIELD

The present invention relates to the field of mobile communication devices and, in particularly, to tagging, processing, and organizing photographs taken with a handheld communication device.

### BACKGROUND

Modern-day handheld communication devices are capable of performing a multitude of tasks such as voice communication, playing music, listen to radio, watching live broadcast television, browsing the Internet, playing games, working with documents, and taking photographs.

The number of mobile communication devices having integrated cameras has more or less exploded in the last couple of years. Nowadays almost every mobile communication device has been fitted with a camera module capable of taking high resolution pictures of good quality. This, together with the development in, and price reduction of, high capacity memories have resulted in that users are taking photographs of people and objects on a more or less daily basis, often resulting in large volumes of photographs.

To easily access taken photos some kind of organization is needed. The most common way to organize photographs is to name the photos depending on their content and then group them accordingly. However, photographs taken with a handheld communication device are often tagged with a cryptic name, generated from some kind of counter in the device, which require the user to manually rename all his or hers photos often using a keypad with a limited number of keys. For example, a user snaps a photo of his son Maximus eating an ice cream. The generated picture in the handheld device is named pict000231.tif. The user then manually selects the picture file and renames it to Maximus eating ice cream.tif and moves the renamed picture file into a folder named Maximus, already containing other pictures of his son. However, renaming and categorizing photos in this manner is a tedious and time-consuming work. Finding an easier way of tagging and categorize photographs would therefore be most welcome.

### SUMMARY OF THE INVENTION

With the above and following description in mind, then, an aspect of the present invention is to provide tagging and organization method, which seeks to mitigate, alleviate, or eliminate one or more of the above-identified deficiencies in the art and disadvantages singly or in any combination.

An aspect of the present invention relates to a method for processing a picture file in a communication device, comprising the steps of, obtaining a picture file, detecting a object in said obtained picture file, recognizing said detected object, comparing said detected object with objects in a database, tagging said picture file depending on said comparison, and organizing said tagged picture file depending on said tagging. The method may also comprise the step of sending a picture file to an external server.

The method may also comprise the step of receiving said picture file from an external server.

The method may also comprise the step of storing said organized picture file in a database.

The method may also comprise that said database is located on an external server.

The method may also comprise that any of the steps detecting, recognizing, tagging, and organizing may be performed on an external server.

The method may also comprise that said detecting comprises extracting any of the following data types; biometrical data, structural data, and color data from said picture file.

The method may also comprise that said detecting comprises extracting metadata from said picture file.

The method may also comprise that said recognition comprise comparing said extracted data types with data type information stored in said database.

The method may also comprise that said method further comprise the step of sending said extracted data types to an external server.

The method may also comprise that said method further comprise the step of receiving said extracted data types from an external server.

The method may also comprise that said tagging involve editing of metadata associated with said picture file.

The method may also comprise that said method further comprising the step of prompting a user based on said comparison.

The method may also comprise that said organizing further comprise any of the steps associating said obtained picture file with other picture files sharing related metadata, and storing said obtained picture file with other picture files sharing related metadata.

The method may also comprise that organizing further comprise associating metadata of said obtained file with metadata in a database comprising picture files with related metadata.

A second aspect of the present invention relates to a communication device for processing a picture file comprising, means for obtaining a picture file, means for detecting an object in said obtained picture file, means for recognizing said detected object, means for comparing said detected object with objects in a database, means for tagging said picture file depending on said comparison, means for organizing said tagged picture file depending on said tagging, a user interface for communicating with a user, and means for communicating with an external database.

The communication device may further comprise that means for detecting further comprise means for extracting any of the following data types; biometrical data, structural data, and color data from said picture file.

The communication device may further comprise that means for detecting further comprise means for extracting metadata from said picture file.

The communication device may further comprise that means for recognition further comprise means for comparing said extracted data types with data type information stored in said database.

The communication device may further comprise that means for tagging further comprise means for editing of metadata associated with said picture file.

The communication device may further comprise that means for prompting a user based on said comparison.

The communication device may further comprise means for associating said obtained picture file with other picture files sharing related metadata, and storing said obtained picture file with other picture files sharing related metadata.

The communication device may further comprise that means for organizing further comprise means for associating metadata of said obtained file with metadata in a database comprising picture files with related metadata.

A third aspect of the present invention relates to a system for processing a picture file in a communication device comprising a module for obtaining a picture file, a module for detecting an object in said obtained picture file, a module for recognizing said detected object, a module for comparing said detected object with objects in a database, a module for tagging said picture file depending on said comparison, a module for organizing said tagged picture file depending on said tagging a module comprising a user interface for communicating with a user, and module for communicating with an external database.

The system may further comprise that the module for detecting further comprise a module for extracting any of the following data types; biometrical data, structural data, and color data from said picture file.

The system may further comprise that the module for detecting further comprise a module for extracting metadata from said picture file.

The system may further comprise that the module for recognition further comprise a module for comparing said extracted data types with data type information stored in said database.

The system may further comprise that the module for tagging further comprise a module for editing of metadata associated with said picture file.

The system may further comprise a module for prompting a user based on said comparison.

The system may further comprise a module for associating said obtained picture file with other picture files sharing related metadata, and storing said obtained picture file with other picture files sharing related metadata.

The system may further comprise that a module for organizing further comprise a module for associating metadata of said obtained file with metadata in a database comprising picture files with related metadata.

Any of the first, second, or third aspect presented above of the present invention may be combined in any way possible.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a front view of a mobile communication device, in this case a mobile phone, according to an embodiment of the present invention; and

FIG. 2 shows a back view of a mobile communication device, in this case a mobile phone, according to an embodiment of the present invention; and

FIG. 3 shows a flowchart describing a tagging and organizing procedure, according to an embodiment of the present invention; and

FIG. 4 shows a another flowchart describing an external tagging and organizing procedure, according to an embodiment of the present invention; and

FIG. 5 shows a communication scenario according to an embodiment of the present invention; and

FIG. 6 shows a picture, according to an embodiment of the present invention.

### DETAILED DESCRIPTION

Embodiments of the present invention relate, in general, to the field of automatic tagging and organization of photos in mobile communication devices. A preferred embodiment relates to a portable communication device, such as a mobile phone, including one or more camera devices. However, it should be appreciated that the invention is as such equally applicable to electronic devices which do not include any radio communication capabilities. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

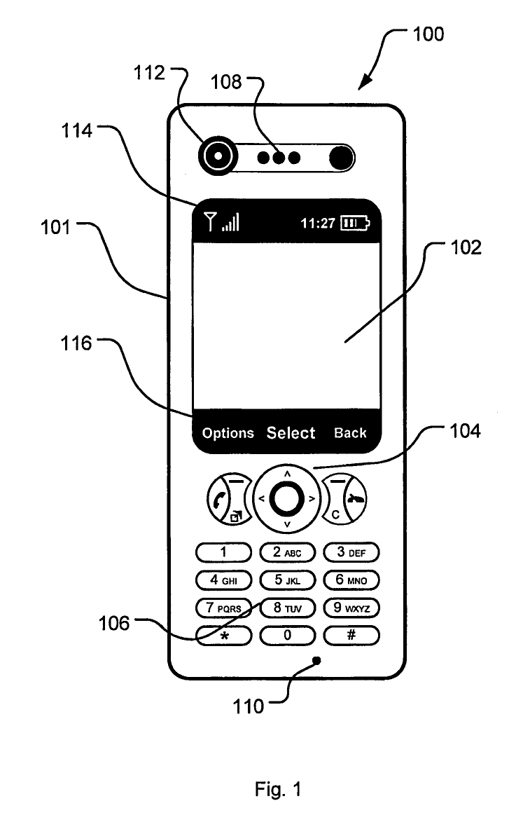

FIG. 1 shows the front side of a mobile communication device 100 comprising a front portion of the casing 101, a display area 102 and means 104 for navigating among items (not shown) displayed in the display area. The display area 102 may comprise a status indication area 114 and one or more softkey bars 116. The status indication area 114 may for example include symbols for indicating battery status, reception quality, speaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The mobile communication apparatus 100 can also comprise other elements normally present in such a device, such as a keypad 106, a speaker 108, a microphone 110, a front camera unit 112, a processor (not shown), a memory (not shown), one or more accelerometers (not shown), a vibration device (not shown), an AM/FM radio transmitter and receiver (not shown), a digital audio broadcast transmitter and receiver (not shown), etc.

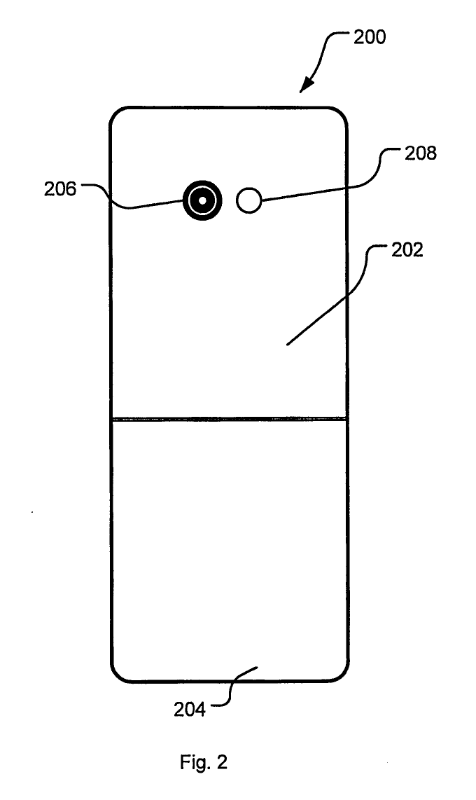

FIG. 2 shows the back side of a mobile communication device 200 comprising a back portion of the casing 202, a backside camera unit with lens 206, a mirror button 208, and a battery hatch 204 concealing and protecting a battery and a SIM-card (Subscriber Identity Module-card).

As described in the background section, the task of manually go through and renaming photos taken with a mobile communication device, often only having a keypad with a limited number of keys, is very tedious and time-consuming. In the following description of embodiments and accompanying drawings, a solution to this tedious task is presented.

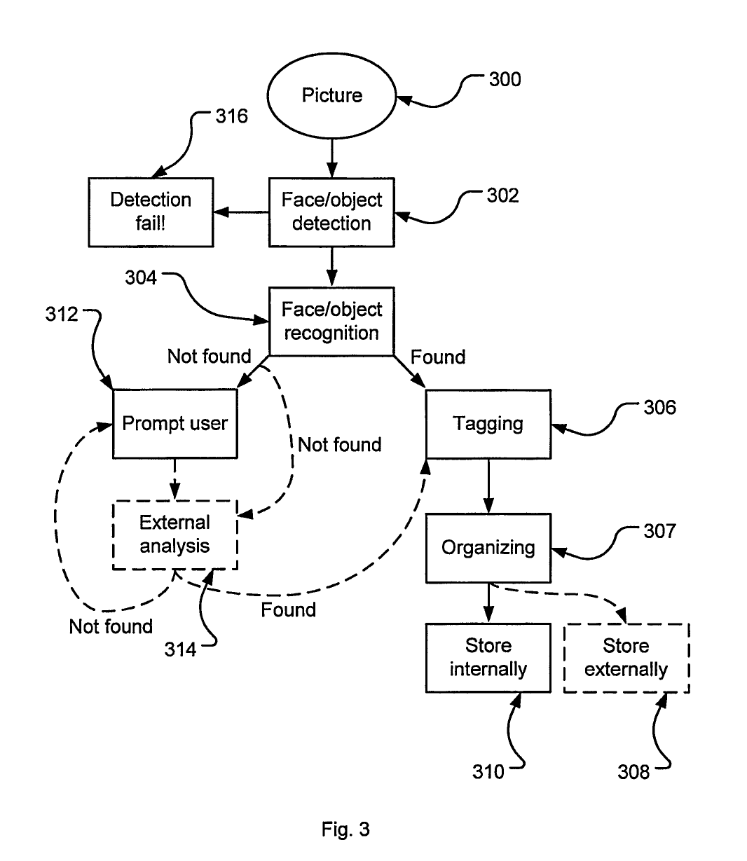

FIG. 3 shows a flowchart describing the tagging and organizing procedure of a picture file, according to an embodiment of the present invention. A picture (also referenced to as a photograph, snapshot, or photo in this application) is taken 300 by a user using a mobile communication device with a camera mounted on/in.

The picture is in 302 subjected to either a face detection process, meaning only faces in the picture are detected, or an object detection process, meaning all types of objects, for instance faces, houses, paintings, persons, animals, plants, clouds, etc., in the photo are detected. The face/object detection process involves detecting and extracting information about the faces/objects present in the picture. The detected and extracted information may be in the form of imagery data, biometric data, object structure data, or any other type of data describing the faces/objects in the picture. The choice weather only faces or objects should be detected may either be factory-preset or user-preset.

In 304 the information resulting from the faces/objects detection procedure 302 is subjected to a recognition process. The information is compared to information stored in a database in the mobile communication device. If no match/matches are found, the user may be prompted 312 to either manually identify the faces/objects in the picture, or optionally (hence the jagged lines) connect and send the picture file or the extracted information, by wire or wireless connection, for external analysis 314. As an option (hence the jagged line), the user may also choose to not be prompted at all, and directly send the extracted information for external analysis on a remote server, when no match is found in the internal database in the device. If the external analysis 314 does not succeed to recognize any faces/objects, the user may be prompted 312 to manually identify the faces/objects in the picture or to discard the tagging and organizing process entirely. If the tagging and organizing process is terminated the picture file will be stored in a temporary storage space, such as a temporary folder, data structure, or a relational database in the mobile communication device. If the external analysis 314 succeeds to recognize any faces/objects, the identification data is sent to a tagging procedure 306.

If the recognition procedure 304 successfully finds a match/matches, either from the internal recognition procedure 304 or the external analysis procedure 314, a tagging procedure is initiated 306. The tagging procedure may involve editing the picture files' metadata. Metadata is the “data about data” and may be internal, such as file name, directory structure, file headers, OCR, SGML, etc., or external, such as external indexes and databases. In our case, where the metadata is connected to a picture image, the metadata would typically include some or all of the following; the name of the picture file, date when the photograph was taken, GPS position of where the photograph was taken, and details of the camera settings such as lens, focal length, aperture, shutter timing, white balance, etc. Also the metadata may include private tags which may be used by a company or a user for special functions, such as place link- or relational-information to metadata in other similar files. Which metadata that is edited in the tagging procedure 306 may either be user-set or factory preset. In one embodiment the tagging procedure 306 replaces only the name of the picture file depending on the name of the person detected in the picture. In another embodiment the tagging procedure 306 replaces other metadata such as the private tag of the picture file depending on the name of the person detected in the picture.

When the tagging procedure is completed in 306 an organization procedure 307 is executed. In the organization procedure 307, the picture file may be organized according to its metadata. The organizing 307 may involve operations like storing the file in a relational database depending on its file name or other metadata, associating the picture file with other kinds of stored information, such as a contact in a mobile phones contacts list, or grouping the picture file with other kind of files or object depending on its metadata.

When the organizing procedure 307 is finished the picture file is stored according to the organization procedure 307. The picture file may be stored internally 310 in the communication device or externally 308 in another storage unit.

The following examples are added to clarify the tagging and organizing process described above.

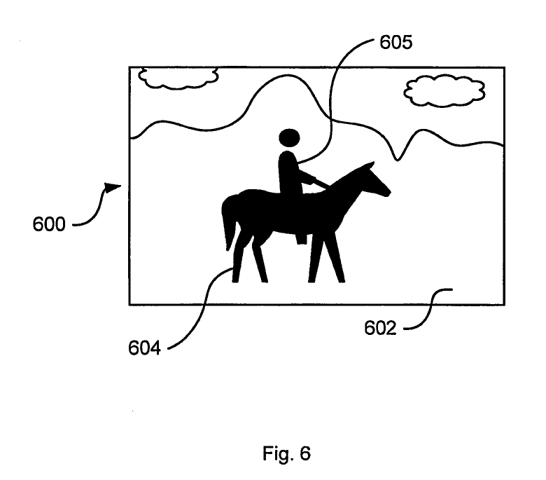

A user takes a picture, using his mobile phone camera, of his friend Bob riding a horse named Bobo, as shown in FIG. 6. The picture 600 shows Bob 605 sitting on Bobo 604 out in the outdoors 603. The user has set the camera to do face detection and face recognition. The face detection process analysis the image data and extracts data describing Bobs 605 face. The data describing Bobs face is sent to the recognition procedure for recognition. Since Bobs face is stored in the recognition database in the users' mobile phone, the recognition procedure gets a match on the data describing Bobs face. The matching information is sent to the tagging procedure which renames (tags the name metadata, or the private tag in metadata) the file ‘Bob’. When the tagging is done the tagged picture file named ‘Bob’ is subjected to an organization procedure where the picture file is moved, from a temporary storage, and saved to a folder or a data structure containing other pictures of Bob. If the camera had been set to detect objects the horse and the clouds may have been detected resulting in a name tagging, or metadata tagging, saying something like ‘Bob riding on Bobo on a cloudy day’. The picture file may have been stored in a folder (or a data structure), containing Bob pictures, in a folder (or a data structure) containing Bobo pictures, or a folder (or a data structure) containing pictures of outdoors activities, or stored in all of them. The picture may also be connected to Bob's contact information (name, address, telephone number, etc.) so when the contact information is viewed, the picture would also be shown or easy accessed, and vise versa.

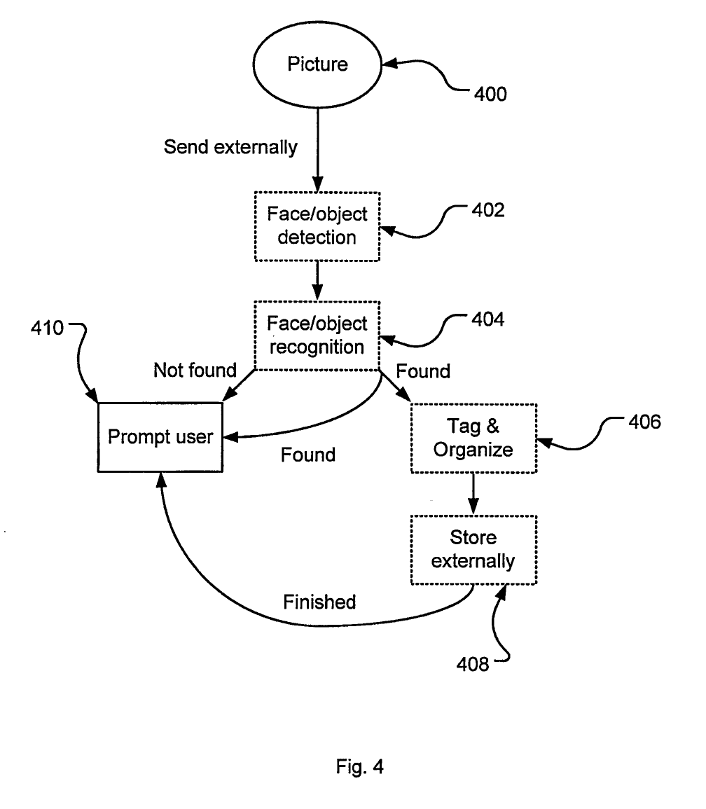

FIG. 4 shows another flowchart describing an external tagging and organizing procedure of a picture file, according to an embodiment of the present invention. In this embodiment a picture is taken in 400. The picture is then sent to an external server, by wire or a wireless connection. The face/object detection 402 and the face/object recognition 404 procedures are performed on the picture file on the external server (indicated by the dashed lines). In this way the saving processing capacity in the mobile communication device and storage space since no recognition database needs to be stored. If one or several matches are found in the recognition procedure 404, a message prompting the user may optionally be sent back to the mobile communication device by the wire or wireless connection. The massage may inform the user that a specific person (face) has been recognized, or that a specific object has been recognized. The picture file on the external server is tagged, organized 406 and stored on the external server 408. When the picture file has been stored a message may be sent to the user prompting 410 him or her that the tagging and organizing process was successful. Also, additional link information may be sent to the users mobile communication device which may be associate with, for instance, the users contact information, so when the contact information is viewed, a link to the picture stored at the external server would also be shown or the picture would automatically be downloaded to the phone and shown together with the contact information. If the detection 402 and recognition 404 fails and no face or object was recognize a message may be sent to the user prompting 410 him or her about it.

An example is provided to clarify the function of the external tagging and organizing procedure. A user is walking in the city. He spots a person that he thinks is a famous person. He takes a photo of that famous person with his mobile phone camera. The mobile phone connects to the internet and the taken picture file is downloaded, for instance by sending the picture as an MMS (Multimedia Messaging Service), to an external server. The external server subjects the photo to a face detection procedure extracting biometric data on the person in the photograph. The biometric data is compared to biometric data over famous persons stored in a database on the external server. The recognition procedure gets a finds a match and sends a message via, for instance SMS (Short Message Service), to the user that took the photo saying that he has photographed ‘Plura’ in the music group Eldkvarn. The picture file is tagged with Pluras' name and the groups name and stored in a (relational) database containing other photos of the group and of ‘Plura’. When the picture is safely stored a message saying that the picture file is stored is sent via, for instance SMS, to the user. Also, additional link information may be downloaded to the user's mobile communication device, so that when the user opens an application listing all his photographed celebrities a link is provided to his picture stored, and maybe additional information, on the external server. The photo may also be shared with other user connecting to the server or maybe sold for profit to a music magazine accessing the database on the server looking for newly taken photos of ‘Plura’. This service may act in a similar manner to the service Track ID™ for music files, but with faces instead (Face ID).

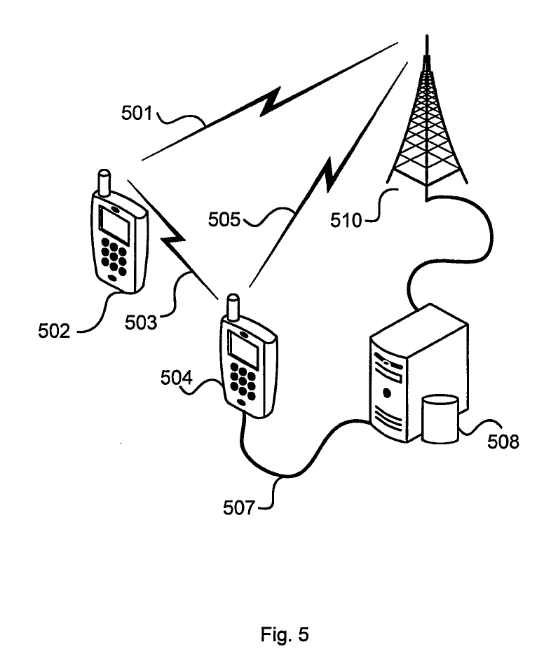

FIG. 5 shows a mobile communication device 504 communicating with an external server according to an embodiment of the present invention. The mobile communication device 504 may be connected to an external server by wire 507 or by a wireless connection 505 communicating with a bas station system 510 connected to an external server 508 running the above described embodiments of the tagging and organizing procedures. Another mobile communication device 502 may either act as a relay station 503, 501, providing a connection to the bas station system 510, or act as a server running the above described embodiments of the tagging and organizing procedures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. Method for processing a picture file in a communication device, comprising the steps of;
obtaining a picture file;
detecting a object in said obtained picture file;
recognizing said detected object;
comparing said detected object with objects in a database;
tagging said picture file depending on said comparison; and
organizing said tagged picture file depending on said tagging.

2. The method according to claim 1, wherein said method further comprise the step of sending picture file to an external server.

3. The method according to claim 1, wherein said method further comprise the step of receiving said picture file from an external server.

4. The method according to claim 1, wherein said further comprise the step of storing said organized picture file in a database.

5. The method according to claim 3, wherein said database is located on an external server.

6. The method according to claim 1, wherein any of the steps detecting, recognizing, tagging, and organizing may be performed on an external server.

7. The method according to claim 1, wherein said detecting comprise extracting any of the following data types; biometrical data, structural data, and color data from said picture file.

8. The method according to claim 1, wherein said detecting comprises extracting metadata from said picture file.

9. The method according to claim 6, wherein said recognition comprise comparing said extracted data types with data type information stored in said database.

10. The method according to claim 8, wherein said method further comprise the step of sending said extracted data types to an external server.

11. The method according to claim 9, wherein said method further comprise the step of receiving said extracted data types from an external server.

12. The method according to claim 1, wherein said tagging involves editing of metadata associated with said picture file.

13. The method according to claim 1, wherein said method further comprising the step of prompting a user based on said comparison.

14. The method according to claim 1, wherein organizing further comprise any of the steps;
associating said obtained picture file with other picture files sharing related metadata; and
storing said obtained picture file with other picture files sharing related metadata.

15. The method according to claim 1, wherein organizing further comprise associating metadata of said obtained file with metadata in a database comprising picture files with related metadata.

16. Communication device for processing a picture file comprising;
means for obtaining a picture file;
means for detecting an object in said obtained picture file;
means for recognizing said detected object;
means for comparing said detected object with objects in a database;
means for tagging said picture file depending on said comparison;
means for organizing said tagged picture file depending on said tagging;
a user interface for communicating with a user; and
means for communicating with an external database.

17. The communication device according to claim 16, wherein means for detecting further comprise means for extracting any of the following data types; biometrical data, structural data, and color data from said picture file.

18. The communication device according to claim 16, wherein means for detecting further comprise means for extracting metadata from said picture file.

19. The communication device according to claim 16, wherein means for recognition further comprise means for comparing said extracted data types with data type information stored in said database.

20. The communication device according to claim 16, wherein means for tagging further comprise means for editing of metadata associated with said picture file.

21. The communication device according to claim 16, further comprise means for prompting a user based on said comparison.

22. The communication device according to claim 16, further comprise means for;
associating said obtained picture file with other picture files sharing related metadata; and
storing said obtained picture file with other picture files sharing related metadata.

23. The communication device according to claim 16, wherein means for organizing further comprise means for associating metadata of said obtained file with metadata in a database comprising picture files with related metadata.

24. A system for processing a picture file in a communication device comprising
module for obtaining a picture file;
module for detecting an object in said obtained picture file;
module for recognizing said detected object;
module for comparing said detected object with objects in a database;
module for tagging said picture file depending on said comparison;
module for organizing said tagged picture file depending on said tagging;
a module comprising a user interface for communicating with a user; and
module for communicating with an external database.

25. The system according to claim 24, wherein the module for detecting further comprise a module for extracting any of the following data types; biometrical data, structural data, and color data from said picture file.

26. The system according to claim 24, wherein the module for detecting further comprise a module for extracting metadata from said picture file.

27. The system according to claim 24, wherein the module for recognition further comprise a module for comparing said extracted data types with data type information stored in said database.

28. The system according to claim 24, wherein the module for tagging further comprise a module for editing of metadata associated with said picture file.

29. The system according to claim 24, further comprise a module for prompting a user based on said comparison.

30. The system according to claim 24, further comprise a module for;
associating said obtained picture file with other picture files sharing related metadata; and
storing said obtained picture file with other picture files sharing related metadata.

31. The system according to claim 24, wherein a module for organizing further comprise a module for associating metadata of said obtained file with metadata in a database comprising picture files with related metadata.
